(19) United States
(12) Patent Application Publication
(10) Pub. No.: US 2017/0185907 A1
(43) Pub. Date: Jun. 29, 2017

(54) METHOD OF PROBABILISTIC INFERENCE USING OPEN STATISTICS

(71) Applicant: International Business Machines Corporation, Armonk, NY (US)

(72) Inventors: Michiharu Kudoh, Kanagawa-ken (JP); Hiroaki Nakamura, Kanagawa-ken (JP); Takayuki Osogami, Kanagawa-ken (JP)

(21) Appl. No.: 15/372,484

(22) Filed: Dec. 8, 2016

(30) Foreign Application Priority Data
Dec. 25, 2015 (JP) 2015-255042

(51) Int. Cl. G06N 7/00

(52) U.S. Cl. CPC G06N 7/005

(57) ABSTRACT

A method is known for identifying a cause and effect relationship between events of equipment by using a Bayesian network, but it has been difficult to comprehensively gather events relating to people. Additionally, there is no known method for estimating the time at which other events occur between two or more events. Provided is an information processing apparatus including a target information obtaining section that obtains known event information relating to at least one known event that has occurred for a target; an information processing apparatus that obtains statistical data relating to events; and an event information generating section that generates unknown event information relating to an unknown event of the target, based on the statistical data and the known event information.

### CROSS-REFERENCE TO RELATED APPLICATION

This application claims the benefit of priority from Japanese Patent Application 2015-255042, filed on Dec. 25, 2015, the contents of which are incorporated herein by reference.

### FIELD OF INVENTION

The present invention relates to an information processing apparatus, an information processing method, and a program for generating unknown event information.

### BACKGROUND

A method is known for automatically generating an insurance plan according to a life event of a customer, as shown in Patent Document 1, for example. In order to propose a suitable plan for the customer, information relating to sensitive life events of the customer such as marriage and child birth is necessary, but it has not been easy to obtain such information from the customer. Furthermore, a method is known for identifying a cause and effect relationship between events of equipment by using a Bayesian network, such as shown in Patent Document 2, for example, but it has been difficult to comprehensively gather events relating to people. Additionally, there is no known method for estimating the time at which other events occur between two or more events.
Patent Document 1: Japanese Patent Application Publication No. 2002-259707.
Patent Document 2: Japanese Patent Application Publication No. 2014-211837.

There is an objective to estimate unknown events occurring for a target, such as a customer, based on known information such as publicly available statistical information.

### SUMMARY OF THE INVENTION

According to a first embodiment of the present invention, provided is an information processing apparatus, including a target information obtaining section that obtains known event information relating to at least one known event that has occurred for a target; an information processing apparatus that obtains statistical data relating to events; and an event information generating section that generates unknown event information relating to an unknown event of the target, based on the statistical data and the known event information.

According to second embodiment of the present invention, provided is an information processing method performed by a computer, including obtaining known event information relating to at least one known event that has occurred for a target; obtaining statistical data relating to events; and generating unknown event information relating to an unknown event of the target, based on the statistical data and the known event information.

According to a third embodiment of the present invention, provided is a program that, when executed by a computer, causes the computer to function as: a target information obtaining section that obtains known event information relating to at least one known event that has occurred for a target; an information processing apparatus that obtains statistical data relating to events; and an event information generating section that generates unknown event information relating to an unknown event of the target, based on the statistical data and the known event information.

### BRIEF DESCRIPTION OF THE DRAWINGS

FIG. 1 is a block diagram of an information processing apparatus 10 according to the present embodiment.

FIG. 2 shows an exemplary process flow of the information processing apparatus 10 according to the present embodiment.

FIG. 3 shows a detailed exemplary process flow of S100 shown in FIG. 2.

FIG. 4 shows exemplary first-order statistical information obtained by the statistics obtaining section 110.

FIG. 5 shows exemplary statistical data relating to events obtained by the statistics obtaining section 110.

FIG. 6 shows event occurrence probability data generated by the probability calculating section 120.

FIG. 7 shows another exemplary process flow of S100 shown in FIG. 2.

FIG. 8 shows an exemplary temporal event table generated by the statistics obtaining section 110.

FIG. 9 shows an exemplary ordered event table generated by the statistics obtaining section 110.

FIG. 10 shows a detailed exemplary process flow of S200 shown in FIG. 2.

FIG. 11 shows a detailed exemplary process flow of S300 shown in FIG. 2.

FIG. 12 shows an exemplary BNS instance i generated by the BN generating section 140.

FIG. 13 shows a detailed exemplary process flow of S500 shown in FIG. 2.

FIG. 14 shows an exemplary process flow from A and onward in FIG. 13.

FIG. 15 shows a detailed exemplary process flow of S600 shown in FIG. 2.

FIG. 16 shows an exemplary hardware configuration of a computer 1900.

### DETAILED DESCRIPTION OF THE PREFERRED EMBODIMENTS

Hereinafter, some embodiments of the present invention will be described. The embodiments do not limit the invention according to the claims, and all the combinations of the features described in the embodiments are not necessarily essential to means provided by aspects of the invention.

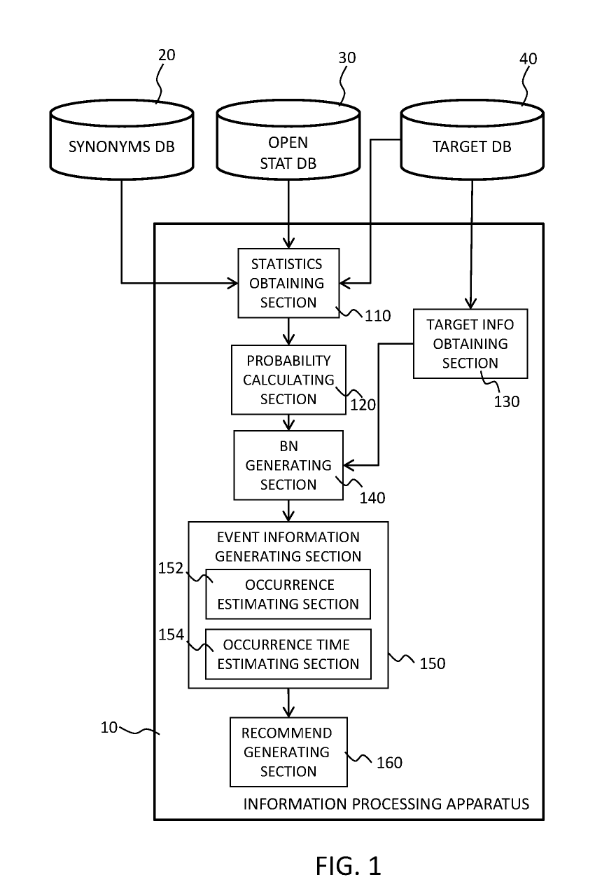

FIG. 1 is a block diagram of an information processing apparatus 10. The information processing apparatus 10 obtains known event information relating to known events of a target and statistical data relating to events, and estimates unknown events of the target based on the known event information and the statistical data. The events can be life events relating to the target, such as marriage, child birth, real estate purchase, or the like, for example. The information processing apparatus 10 includes a statistics obtaining section 110, a probability calculating section 120, a target information obtaining section 130, a BN generating section 140, an event information generating section 150, and a recommend generating section 160.

The statistics obtaining section 110 obtains the statistical data relating to events. The statistics obtaining section 110 can generate and obtain the statistical data relating to events, based on publicly available statistical information. For example, the statistics obtaining section 110 can obtain first-order statistical information from an open statistics database 30, which can be a server outside of the information processing apparatus 10, obtain synonym data including a plurality of expressions relating to events from a synonyms database 20, which is a server outside of the information processing apparatus 10, and generate the statistical data relating to the events from the first-order statistical information by using the synonym data.

The statistics obtaining section 110 obtains the known event information including information of known events relating to a plurality of targets from a target database 40, which can be a server outside of the information processing apparatus 10, and can generate the statistical data from the known event information of the plurality of targets. The statistics obtaining section 110 supplies the probability calculating section 120 with the generated statistical data relating to events. The probability calculating section 120 calculates the occurrence probability of an event based on the statistical data relating to events. For example, the probability calculating section 120 calculates the occurrence probability of a second event occurring when a first event occurs, based on the statistical data relating to events. Furthermore, the probability calculating section 120 calculates the occurrence probability of a second event occurring when a first event occurs for each time interval between the first event and the second event. The probability calculating section 120 supplies the BN generating section 140 with the calculated event occurrence probability.

The target information obtaining section 130 obtains association information of a target and known event information relating to at least one known event that has occurred for the target. For example, the target information obtaining section 130 obtains profile information of each target as the association information from the target database 40, which can be a server outside of the information processing apparatus 10, and further obtains the information relating to events for each target as the known event information of each target. The target information obtaining section 130 supplies the BN generating section 140 with the obtained information.

The BN generating section 140 generates a Bayesian network (BN) that includes a plurality of events as nodes and expresses the correlation relationship between events, based on the event occurrence probability calculated by the probability calculating section 120. The BN generating section 140 generates, for each node in the Bayesian network, a conditional probability table without time intervals and a conditional probability table having time intervals including the occurrence probability of the event for each time interval. The BN generating section 140 can generate the Bayesian network for each target based on the known event information and the association information of the target. The BN generating section 140 supplies the event information generating section 150 with the generated Bayesian network.

The event information generating section 150 generates the unknown event information relating to an unknown event of the target, based on the Bayesian network generated on the basis of the known event information and the statistical data relating to events. An unknown event of a target can be an event that is not a known event among the events corresponding to a node included in the Bayesian network. For example, an unknown event of a target can include an event for which it is unknown whether the event has occurred for the target, or an event for which the occurrence time at which the event occurred for the target is unknown.

The unknown event information can include information concerning whether or not an unknown event has occurred and/or the occurrence time of an unknown event. The event information generating section 150 includes an occurrence estimating section 152 and an occurrence time estimating section 154.

The occurrence estimating section 152 estimates whether an unknown event of a target has occurred for the target from the known event information, based on the conditional probability table without time intervals of the Bayesian network.

The occurrence time estimating section 154 estimates the time at which an unknown event has occurred for the target, based on the conditional probability table having time intervals. The event information generating section 150 supplies the recommend generating section 160 with the unknown event information including the estimation result of at least one of the occurrence estimating section 152 and the occurrence time estimating section 154.

The recommend generating section 160 generates information to be recommended to the target in relation to the unknown event, based on the unknown event information. For example, the recommend generating section 160 generates information recommending a product or the like corresponding to the event occurrence time or the event estimated to have occurred for the target, according to the unknown event information. The recommend generating section 160 can transmit the generated information to the target.

In this way, the information processing apparatus 10 of the present embodiment generates a Bayesian network that includes events as nodes and includes a conditional probability table having time intervals, based on the public first-order statistical information, the known information relating to known events of the target, and the like. In this way, the information processing apparatus 10 can estimate whether unknown events have occurred for a target and the occurrence time of unknown events by utilizing the Bayesian network, and can provide a suitable recommendation for each target.

At least one of the synonyms database 20, the open statistics database 30, and the target database 40 can be realized by a storage apparatus included inside of the information processing apparatus 10, instead of as a server outside of the information processing apparatus 10.

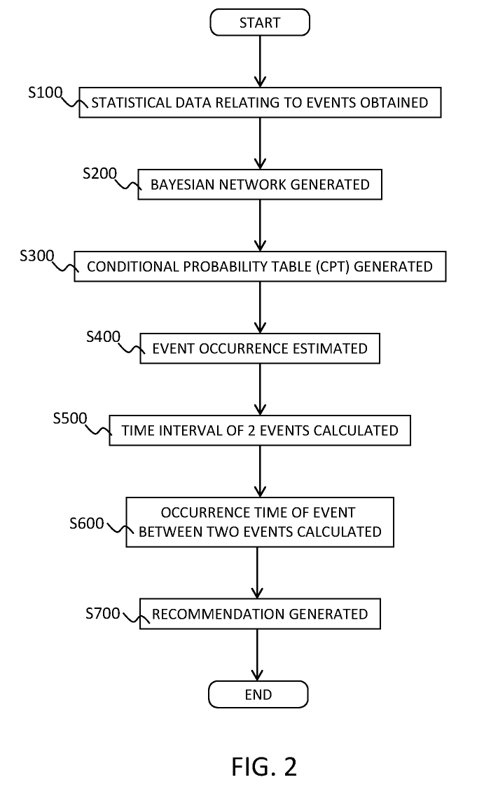

FIG. 2 shows an exemplary process flow of the information processing apparatus 10 according to the present embodiment. In the present embodiment, by performing the processing from S100 to S700, the information processing apparatus 10 estimates unknown events of a target and generates a recommendation according to the estimation results.

At S100, the statistics obtaining section 110 obtains the statistical data relating to events. For example, the statistics obtaining section 110 can obtain first-order statistical information by accessing the open statistics database 30, and obtain the statistical data relating to events based on this first-order statistical information.

The statistics obtaining section 110 can obtain the known event information of a plurality of targets by accessing the target database 40, and generate and obtain the statistical data relating to events by aggregating the known event information of the plurality of targets. The statistics obtaining section 110 supplies the probability calculating section 120 with the generated statistical data relating to events.

The probability calculating section 120 calculates the event occurrence probability based on the statistical data relating to events. The probability calculating section 120 supplies the BN generating section 140 with the calculated event occurrence probability. The processing at S100 is described in detail further below.

Next, at S200, the BN generating section 140 generates the Bayesian network (BN) expressing the correlation relationship between events, based on the event occurrence probability. For example, the BN generating section 140 generates a Bayesian network structure in which a plurality of events are included respectively as nodes. The processing at S200 is described in detail further below.

Next, at S300, the BN generating section 140 generates the conditional probability table having time intervals, for each node in the Bayesian network structure. For example, the target information obtaining section 130 obtains the known event information and association data for each target from the target database 40, and supplies this information and data to the BN generating section 140.

The BN generating section 140 calculates the event occurrence probability corresponding to each node in the Bayesian network for each target, based on the Bayesian network generated at S200 and the known event information and association information of each target obtained from the target information obtaining section 130. For example, the BN generating section 140 generates a conditional probability table having time intervals including the event occurrence probability for each time interval, and a conditional probability table without time intervals including the occurrence probability of events that do not include time intervals. The BN generating section 140 supplies the event information generating section 150 with each generated event occurrence probability. The processing at S300 is described in detail further below.

Next, at S400, the event information generating section 150 estimates whether an unknown event of a target has occurred for the target, from the known event information. For example, if an event occurrence probability in a conditional probability table without a time interval in the Bayesian network is greater than or equal to a predetermined threshold value, e.g. 50%, the occurrence estimating section 152 of the event information generating section 150 can estimate that this unknown event has occurred for the target, and can generate unknown event information indicating that this event has occurred in response to this unknown event.

Next, at S500, the event information generating section 150 estimates the time interval between the two known events of the target, based on the conditional probability table having time intervals. The event information generating section 150 generates the unknown event information that includes the estimated time interval between the two known events. For example, for one event, the event information generating section 150 generates unknown event information that includes information of a time interval from a time when the previous event occurred to a time when the one event occurred. The processing at S500 is described in detail further below.

Next, at S600, the event information generating section 150 estimates the occurrence time of an event sandwiched between the two known events, based on the conditional probability table having time intervals. The event information generating section 150 generates unknown event information that includes the occurrence time of this sandwiched event, based on the event sandwiched between these two known events. The processing at S600 is described in detail further below. The processing from S400 to S600 can be performed in an order differing from the order described in FIG. 2.

Next, at S700, the recommend generating section 160 generates information to be recommended to the target in relation to the unknown event, based on the unknown event information. The recommend generating section 160 can generate the information to be recommended for each target. The recommend generating section 160 generates the information to be recommended for the unknown event indicated by the unknown event information as having occurred for the target. For example, if the unknown event information indicates that the one event has occurred, the recommend generating section 160 generates information recommending a product relating to this one unknown event.

As an example, the recommend generating section 160 generates information concerning a product to be recommended in relation to a marriage, e.g. life insurance, based on the unknown event information indicating that a certain target has gotten married.

If the unknown event information indicates an occurrence time of one event whose occurrence time was unknown, the recommend generating section 160 generates information recommending a product corresponding to the occurrence time of the event, in relation to the one event. For example, the recommend generating section 160 generates information concerning a product to be recommended in relation to a situation occurring three years after child birth, e.g. educational endowment insurance or toddler products, based on the unknown event information indicating that a certain target gave birth three years ago.

The information processing apparatus 10 can be used by a salesperson who proposes products or the like to targets, and in this case, the recommend generating section 160 can generate the information to be recommended as sales material. The information processing apparatus 10 can be used by the targets themselves either directly or indirectly via the Internet, for example, and in this case, the recommend generating section 160 can generate the information to be recommended as a product suggestion transmitted to the target. In addition to recommend, the recommend generating section 160 can generate a question to the target in relation to the event of the unknown event information.

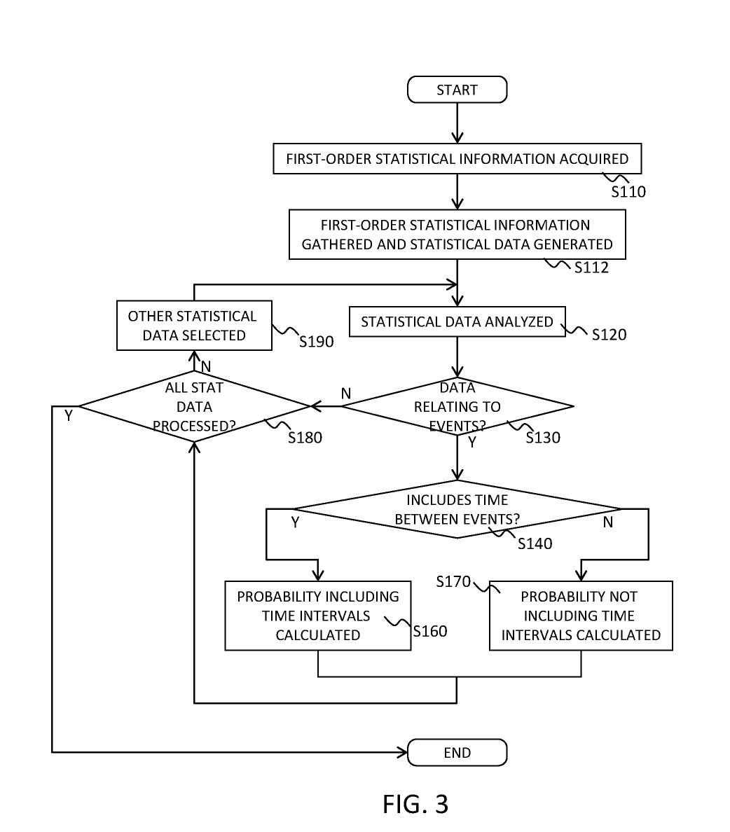

FIG. 3 shows a detailed exemplary process flow of S100 shown in FIG. 2. In the present embodiment, the information processing apparatus 10 can perform the processing of S100 by performing the processing from S110 to S190. The information processing apparatus 10 generates the statistical data relating to events based on the statistical information disclosed by performing the flow shown in FIG. 3.

First, at S110, the statistics obtaining section 110 obtains the public first-order statistical information. For example, the statistics obtaining section 110 accesses the open statistics database 30, which is a database that can be accessed by anyone and stores general data made public by a government agency or business, for example, and obtains statistical information stored in the open statistics database 30 as the first-order statistical information.

Next, at S112, the statistics obtaining section 110 edits the first-order statistical information obtained at S110 to generate a pieces of statistical data. For example, the statistics obtaining section 110 normalizes, summarizes, and/or merges data of one or more tables or the like included in the first-order statistical information to generate well-ordered statistical data. If the first-order statistical information includes statistical information classified into categories, e.g. gender, region, and/or age range, the statistics obtaining section 110 can generate statistical data classified into each category.

Next, at S120, the statistics obtaining section 110 selects and analyzes one piece of statistical data from among the pieces of statistical data generated at S112. For example, the statistics obtaining section 110 obtains synonym data including a plurality of expressions relating to events from the synonyms database 20, and judges whether the statistical data that is the analysis target is statistical data relating to events, based on the synonym data. As an example, the statistics obtaining section 110 performs expression matching for statistical data that matches expressions relating to two events, based on the synonym data included in one or more expressions for each event.

If the statistical data includes expressions relating to two different events, the statistics obtaining section 110 determines that this statistical data is statistical data relating to events. The statistics obtaining section 110 can repeatedly perform the judgment using matching for each combination of two different events. Thereby, the statistics obtaining section 110 can accurately extract statistics about events from the first-order statistical information by utilizing the synonyms database 20.

Next, at S130, the statistics obtaining section 110 judges whether the statistical data analyzed immediately before at S120 is statistical data relating to events, based on the analysis result of S120. If this statistical data is statistical data relating to events, the statistics obtaining section 110 obtains this statistical data relating to events and proceeds to the processing of S140, and if this statistical data is not statistical data relating to events, the statistics obtaining section 110 proceeds to the processing of S180.

In this way, the statistics obtaining section 110 can obtain statistical data indicating a correlation relationship between two events. For example, when a certain event, e.g. marriage, has occurred, the statistics obtaining section 110 obtains statistical data relating to events indicating the number of occurrences (or ratio of occurrences) of another event, e.g. child birth.

Next, at S140, the statistics obtaining section 110 judges whether the obtained statistical data relating to events includes information concerning a time interval between the two events. For example, the statistics obtaining section 110 judges whether the obtained statistical data includes expressions relating to a time interval, such as “time passed” or “interval.” If the obtained statistical data is judged to include information concerning a time interval, the statistics obtaining section 110 proceeds to the processing of S160, and if the obtained statistical data is not judged to include information concerning a time interval, the statistics obtaining section 110 proceeds to the processing of S170.

Next, at S160, the probability calculating section 120 calculates the event occurrence probability, based on the statistical data relating to events that includes the information concerning a time interval. For example, the probability calculating section 120 generates information of event transitions between two events, based on the statistical data including information concerning the time interval between the two events. For example, if the statistical data relating to events includes the number of transitions from one event to another later event, the probability calculating section 120 generates information concerning the event transition from the one event to the other event.

Furthermore, the probability calculating section 120 calculates the probability of, when one event has occurred, another event occurring after (or having occurred before) this one event, for each time interval from the one event. The probability calculating section 120 can generate event occurrence probability data that includes the calculated event occurrence probability for each time interval. The probability calculating section 120 supplies the BN generating section 140 with the generated event occurrence probability data. The probability calculating section 120 then proceeds to the processing of S180.

Next, at S170, the probability calculating section 120 calculates the event occurrence probability based on the statistical data relating to events that does not include information concerning a time interval. For example, the probability calculating section 120 generates information concerning the event transition between two events based on the statistical data relating to events that does not include information concerning a time interval. For example, if the statistical data relating to events includes the number of transitions from one event to another later event, the probability calculating section 120 generates information concerning the event transition from the one event to the other event.

Furthermore, the probability calculating section 120 calculates the probability of, when one event has occurred, another event occurring after (or having occurred before) this one event. The probability calculating section 120 can generate event occurrence probability data that includes the calculated event occurrence probability. The probability calculating section 120 supplies the BN generating section 140 with the generated event occurrence probability data. The probability calculating section 120 then proceeds to the processing of S180.

At S180, the statistics obtaining section 110 judges whether the processing of S120 to S170 has been completed for all of the statistical data generated at S112. If it is judged that all of the statistical data has been processed, the statistics obtaining section 110 ends the processing of S100, and if it is judged that all of the statistical data has not been processed, the statistics obtaining section 110 proceeds to the processing of S190.

At S190, the statistics obtaining section 110 selects statistical data that has not yet been selected from among the statistical data generated at S112, and begins the processing of S120 for the newly selected statistical data.

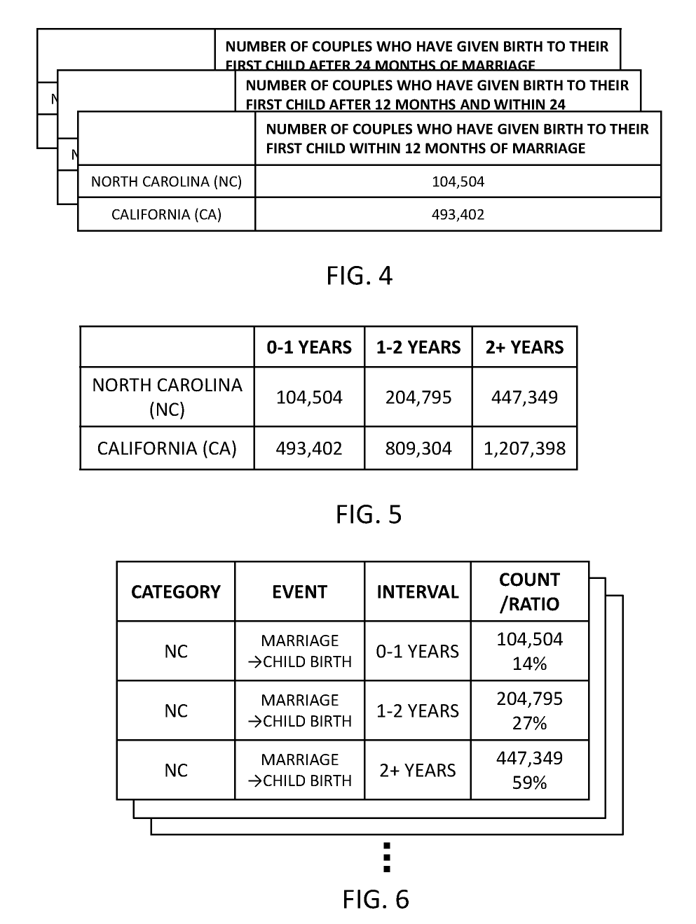

FIG. 4 shows exemplary first-order statistical information obtained by the statistics obtaining section 110. The first-order statistical information shown in FIG. 4 includes a table formed by gathering “number of couples who have given birth to their first child within 12 months of marriage,” “number of couples who have given birth to their first child after 12 months and within 24 months of marriage,” and “number of couples who have given birth to their first child after 24 months of marriage” for each of a plurality of regions, which are North Carolina (NC) and California (CA). For example, the statistics obtaining section 110 can obtain the table shown in FIG. 4 as the first-order statistical information at S110.

FIG. 5 shows exemplary statistical data relating to events obtained by the statistics obtaining section 110. For example, at S112, the statistics obtaining section 110 can generate the statistical data shown in FIG. 5 by combining the three tables shown in FIG. 4, which are first-order statistical information. The statistical data of FIG. 5 includes two categories relating to the region, which are North Carolina (NC) and California (CA), and, for each category, indicates the number of targets (couples) for which the event “child birth” has occurred within 1 year of the event “marriage,” the number of targets (couples) for which the event “child birth” has occurred after 1 year and within 2 years of the event “marriage,” and the number of targets (couples) for which the event “child birth” has occurred after 2 years of the event “marriage.”

FIG. 6 shows event occurrence probability data generated by the probability calculating section 120. For example, at S160, the probability calculating section 120 can generate the event occurrence probability data as shown in FIG. 6 for each category, from the statistical data relating to events shown in FIG. 5. The event occurrence probability data shown in FIG. 6 includes the occurrence probability of the event “child birth” within 1 year of the event “marriage,” the occurrence probability of the event “child birth” after 1 year and within 2 years of the event “marriage,” and the occurrence probability of the event “child birth” after 2 years of the event “marriage,” for the category of North Carolina (NC). As shown in FIG. 6, in addition to the occurrence probability, the event occurrence probability data can include an occurrence number (the count shown in the drawing) of the events for each time interval.

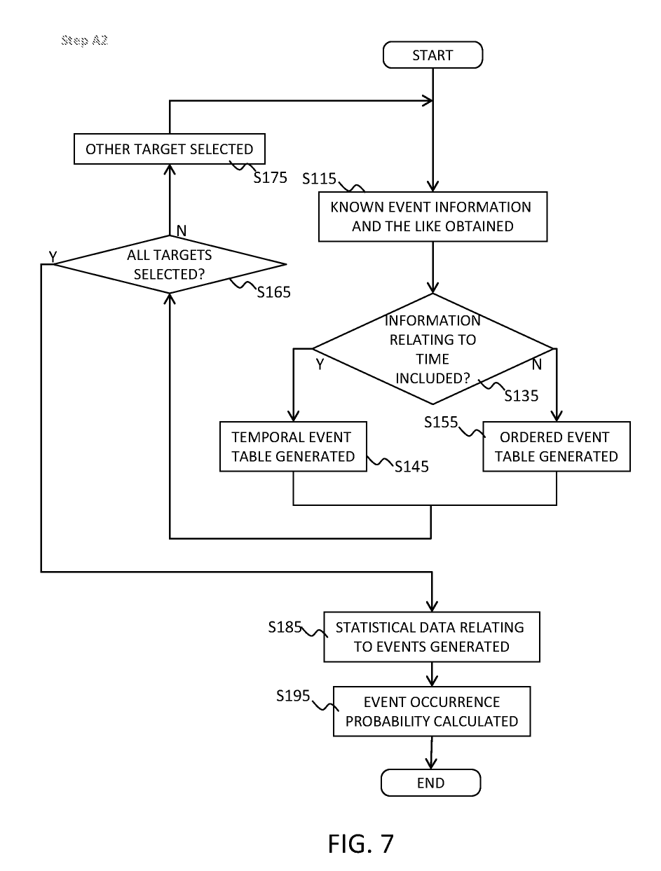

FIG. 7 shows another exemplary process flow for S100 of FIG. 2. In the processing of S100 of FIG. 2, the information processing apparatus 10 can performing the processing of S115 to S195 shown in FIG. 7 instead of or in addition to the flow of S110 to S190 shown in FIG. 3. The information processing apparatus 10 generates the statistical data relating to events based on information relating to a target event by performing the flow shown in FIG. 7.

At S115, the statistics obtaining section 110 obtains the association information of one target and the known event information relating to a known event of the one target, from the target database 40. For example, the statistics obtaining section 110 obtains, as the known event information of the one target, information relating to a life event of the one target, e.g. marriage, child birth, moving homes, transferring jobs, and/or retirement of the one target or of a close relative of the one target, obtained by a salesperson through conversation with the target and registered in advance in the target database 40. The statistics obtaining section 110 can obtain information for the point in time when the known event information was registered in the target database 40. The statistics obtaining section 110 can obtain a plurality of pieces of known event information for one target.

If the target database 40 includes information other than information relating to events, the statistics obtaining section 110 can obtain synonym data that includes a plurality of expressions relating to events from the synonyms database 20 of the information processing apparatus 10, and extract and obtain known event information relating to events of the one target by performing matching using the synonym data.

Next, at S135, the statistics obtaining section 110 judges whether the known event information of the target obtained at the most recent S115 includes information relating to time. For example, the statistics obtaining section 110 judges whether the known event information of the target includes an event occurrence time, e.g. an occurrence year, a season in which the event occurred, an occurrence month, or an occurrence date and time. If it is judged that the known event information includes information relating to time, the statistics obtaining section 110 proceeds to the processing of S145, and if it is not judged that the known event information includes information relating to time, the statistics obtaining section 110 moves to the processing of S155.

At S145, the statistics obtaining section 110 generates an entry in a temporal event table for the target. The temporal event table includes a plurality of entries for each piece of known event information of a plurality of targets, and each entry includes information concerning a known event and an occurrence time according to the known event information. The statistics obtaining section 110 then proceeds to the processing of S165.

At S155, the statistics obtaining section 110 generates an entry of an ordered event table for the target. The ordered event table includes a plurality of entries for each piece of known event information for a plurality of targets, and each entry includes information concerning a known event and an occurrence order, according to the known event information. The statistics obtaining section 110 can set the order in which the pieces of known event information are registered in the target database 40 to be the occurrence order in the ordered event table. The statistics obtaining section 110 then proceeds to the processing of S165.

At S165, the statistics obtaining section 110 judges whether the processing from S115 to S155 has been performed for all of the targets recorded in the target database 40. If it is judged that the processing has been completed for all of the targets, the statistics obtaining section 110 proceeds to the processing of S185, and if it is not judged that the processing has been completed for all of the targets, the statistics obtaining section 110 proceeds to the processing of S175.

At S175, the statistics obtaining section 110 selects another target that has not yet been selected, and begins the processing of S115 for the newly selected target.

At S185, the statistics obtaining section 110 generates and obtains the statistical data relating to events. For example, the statistics obtaining section 110 generates the statistical data relating to events having time intervals based on the temporal event table generated at S145 for a plurality of targets. As an example, the statistics obtaining section 110 calculates the time intervals between events for each target from the temporal event table, and generates the statistical data relating to events having time intervals similar to the table shown in FIG. 5, based on the calculated time intervals.

Furthermore, the statistics obtaining section 110 generates the statistical data relating to events without time intervals based on the ordered event table generated at S155 for a plurality of targets, for example. As an example of this, the statistics obtaining section 110 determines the order relationship among the events for each target from the ordered event table, and generates the statistical data relating to events without time intervals that indicates the occurrence probability of another event occurring after one event has occurred.

The statistics obtaining section 110 can generate the statistical data relating to events for categories with which a plurality of targets are associated. For example, the statistics obtaining section 110 can classify all of the targets into a plurality of categories, based on the association information of the targets obtained at S115, and generate the statistical data relating to events for each target associated with each category. The statistics obtaining section 110 supplies the probability calculating section 120 with the generated statistical data relating to events.

At S195, the probability calculating section 120 calculates the event occurrence probability based on the statistical data relating to events. For example, the probability calculating section 120 generates information concerning the event transition between two events, based on the statistical data relating to events with time intervals. If the statistical information relating to events includes the number of transitions from one event that has statistical data relating to events to another later event, for example, the probability calculating section 120 generates information concerning the event transition from the one event to the other event.

The probability calculating section 120 calculates the probability of, when one event has occurred, another event occurring after (or having occurred before) this one event, for each time interval from the one event. The probability calculating section 120 can generate event occurrence probability data that includes the calculated event occurrence probability for each time interval. As an example, the probability calculating section 120 can generate event occurrence probability data similar to the table shown in FIG. 6.

Furthermore, the probability calculating section 120 generates the information concerning event transition between two events, based on the statistical data relating to events without time intervals, and calculates the probability of, when one event has occurred, another event occurring after (or having occurred before) this one event, for each time interval from the one event. The probability calculating section 120 supplies the BN generating section 140 with the generated event occurrence probability data.

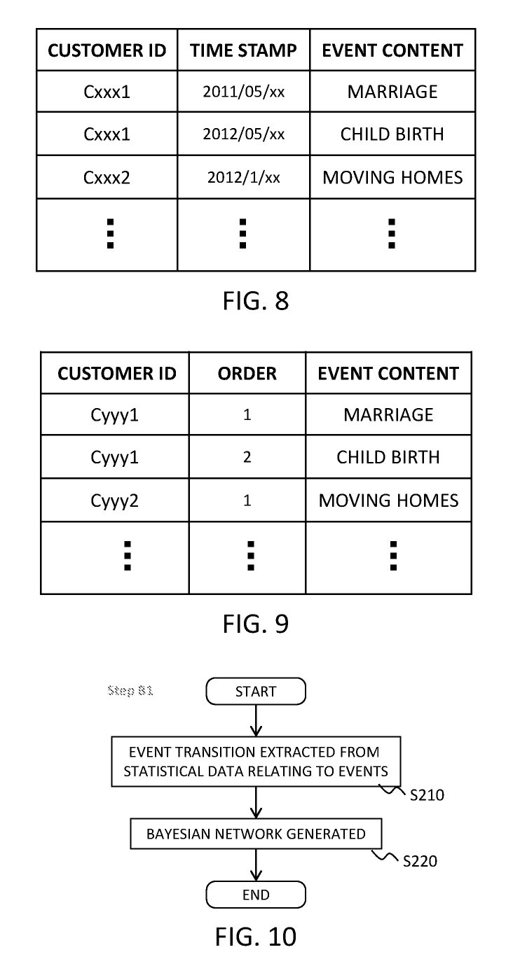

FIG. 8 shows an exemplary temporal event table generated by the statistics obtaining section 110 at S145. As shown in the drawing, the temporal event table can include an occurrence time indicated by a time stamp and event content for each of a target Cxxx1 and a target Cxxx2 identified by customer IDs.

FIG. 9 shows an exemplary ordered event table generated by the statistics obtaining section 110 at S155. As shown in the drawing, the ordered event table can include an event occurrence order and event content for each of a target Cyyy1 and a target Cyyy2 identified by customer IDs.

FIG. 10 shows a detailed exemplary process flow of S200 shown in FIG. 2. As shown in the drawing, in the present embodiment, the information processing apparatus 10 can perform the processing of S200 by performing the processing from S210 to S220.

First, at S210, the BN generating section 140 extracts the event transition from the statistical data relating to events. For example, the BN generating section 140 extracts the information relating to the event transition from the event occurrence probability data generated at S160, S170, and/or S195. As an example, for each one event, the BN generating section 140 extracts another event that has a high probability of having occurred before this one event occurs.

Next, at S220, the BN generating section 140 generates the Bayesian network structure in which each event is a node, based on the information relating to the event transition. For example, by setting each other event that has occurred before the one event as a parent node candidate and evaluating the parent node candidates, the BN generating section 140 can generate the Bayesian network structure based on a K2 algorithm.

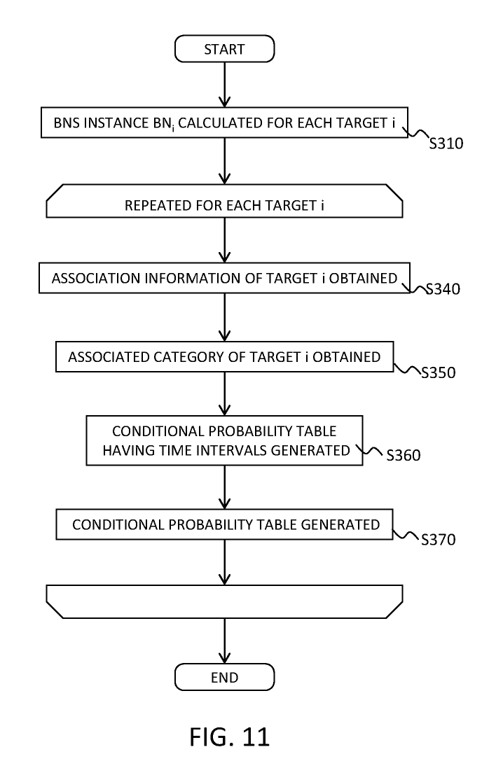

FIG. 11 shows a detailed exemplary process flow of S300 shown in FIG. 2. As shown in the drawing, in the present embodiment, the information processing apparatus 10 can perform the processing of S300 by performing the processing from S310 to S370.

First, at S310, the BN generating section 140 generates a Bayesian network structure instance for each target i (i ε I) among a plurality of targets, e.g. I targets. Next, the BN generating section 140 repeatedly performs the processing from S340 to S370 for each target i. At S340, the BN generating section 140 obtains the association information of the target i. For example, the target information obtaining section 130 obtains from the target database 40 the association information indicating a characteristic of the target i, e.g. profile information indicating gender, age range, job type, region of residence, and the like, and supplies the association information to the BN generating section 140. The BN generating section 140 obtains the association information of the target i from the target information obtaining section 130.

At S350, the BN generating section 140 determines the category gᵢ with which the target is associated, based on the association of the target i obtained at S340 from among the categories included in the event occurrence probability data. For example, if the association information of the target i indicates residence in North Carolina (NC), the category gᵢ of the target i can be determined to be the category “North Carolina (NC).”

The BN generating section 140 can determine a plurality (K) of categories gᵢ₁, gᵢ₂, . . . , g_{iK} that conform with the association information of the target i. Here, it is acceptable for the BN generating section 140 to select just a portion of the categories from among the plurality of categories. For example, with sᵢₖ representing the number of occurrences of events included in the event occurrence probability data for each category gᵢₖ, the BN generating section 140 can select a portion of the categories such that the total (Σ^{K}sᵢₖ) of the number of occurrences of events in all categories of a target i is within a predetermined range. In this way, the BN generating section 140 can identify event occurrence probability data having a strong affinity with the target i, from among the event occurrence probability data of the plurality of categories according to a certain event transition, e.g. a transition from the event “marriage” to the event “child birth.”

If there is a level of categories below gᵢ₁, gᵢ₂, . . . , gᵢK, e.g. if there is a relationship between state and city in a case where the association information includes geographical regions, the BN generating section 140 can identify the lowest level of category matching the association information of the target i and use this lowest level category instead of a higher level category.

Next, at S360, the BN generating section 140 generates the conditional probability table having time intervals for the target i. For example, the BN generating section 140 generates the conditional probability table having time intervals in the nodes of the Bayesian network, based on information including the event occurrence probability for each time interval within the event occurrence probability data specified for the target i at S350.

As an example, the BN generating section 140 generates the conditional probability table having time intervals based on the event occurrence probability data including the event occurrence probability for each time interval shown in FIG. 6. For the node “child birth” in the BNS instance i of the target i residing in North Carolina (NC), the BN generating section 140 generates a conditional probability table that includes a probability for each time interval of transitioning from the node “marriage.” In this case, the BN generating section 140 can assign a probability of 14% to the time interval of “0-1 years,” can assign a probability of 27% to the time interval of “1-2 years,” and can assign a probability of 59% to the time interval of “more than 2 years.”

Here, the BN generating section 140 can generate the conditional probability table based on the known event information of the target i. For example, the BN generating section 140 obtains from the target database 40 the known event information of the target i. If the known event information indicates that an event corresponding to a specified node has occurred at a specified time, the BN generating section 140 creates a conditional probability table having time intervals corresponding to this known event information. As an example, if the known event information of the target i indicates that “child birth occurred 15 months after marriage,” for the node “child birth” in the BNS instance i, the BN generating section 140 can assign a probability of 0% to the time intervals of “0-1 years” and “more than 2 years” and assign a probability of 100% to the time interval of “1-2 years.”

Next, at S370, the BN generating section 140 generates the conditional probability table for the target i. For example, the BN generating section 140 generates the conditional probability table having time intervals in the nodes of the Bayesian network, based on information that does not include the event occurrence probability for each time interval within the event occurrence probability data specified for the target i at S350. As an example, the BN generating section 140 generates a conditional probability table that includes the probability of the event “child birth” occurring for the node corresponding to the event “marriage” in the BNS instance i of the target i residing in NC, based on the event occurrence probability data that includes the event occurrence probability for each time interval shown in FIG. 6.

Here, the BN generating section 140 can generate the conditional probability table based on the known event information of the target i in the same manner as in S360. The BN generating section 140 supplies the event information generating section 150 with the BNS instance i generated for each target i. Furthermore, the BN generating section 140 can supply the event information generating section 150 with the known event information of the target i.

By repeating the processing from S340 to S370 for each target i, the BN generating section 140 generates a BNS instance i that includes information of the Bayesian network unique to each target i, based on the categories with which the target i is associated and the known event information of the target i. In this way, in S400 to S600, the event information generating section 150 generates the unknown event information based on the statistical data of the categories with which the target i is associated.

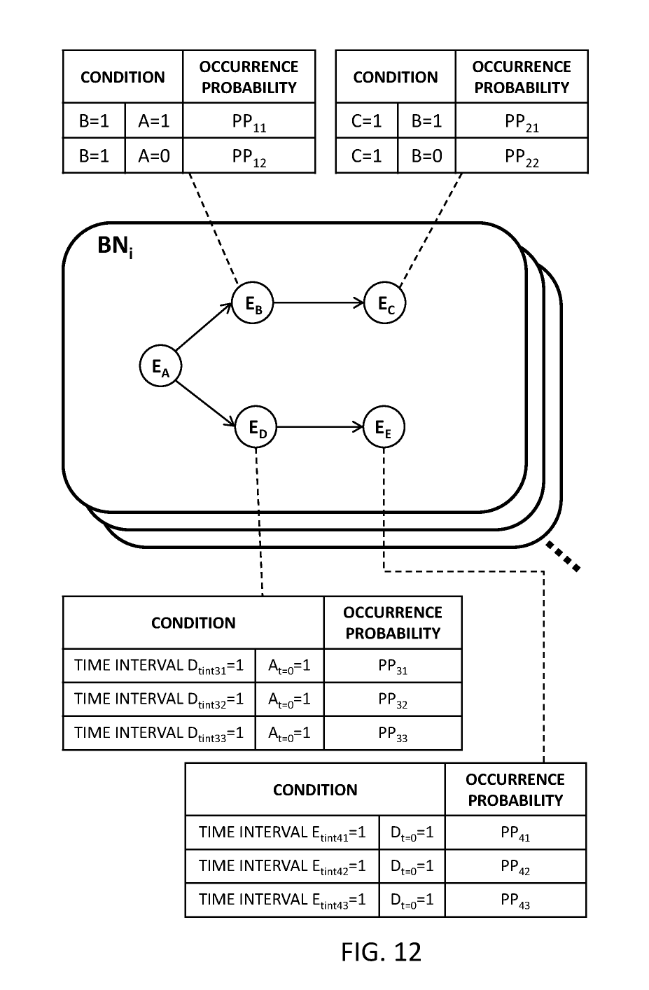

FIG. 12 shows an exemplary BNS instance i generated by the BN generating section 140. In the example of FIG. 12, the BN generating section 140 generates a BNS instance i that includes a node E_{A}, a node E_{B}, a node E_{C}, a node E_{D}, and a node E_{E} for the target i at S210. The nodes E_{A} to E_{E} correspond to events E_{A} to E_{E}. This BNS instance i shows that there is a cause and effect relationship between the occurrence of the event E_{A} and the occurrences of the event E_{B} and the event E_{D}, a cause and effect relationship between the occurrence of the event E_{B} and the occurrence of the event E_{C}, and a cause and effect relationship between the occurrence of the event E_{D} and the occurrence of the event E_{E}.

FIG. 12 includes the conditional probability table having time intervals and the conditional probability table without time intervals created for each node by the BN generating section 140. For example, the conditional probability table with no time intervals of the node E_{B} shows that there is a probability (PP₁₁) of the event E_{B} occurring when the event E_{A} has occurred (A=1) and a probability (PP₁₂) of the event E_{B} occurring if the event E_{A} has not occurred. For the node E_{C}, a probability of (PP₂₁) and a probability of (PP₂₂) are shown in the same manner as the node E_{B}.

As a further example, the conditional probability table having time intervals of the node E_{D} shows that there is a probability (PP₃₁) of the event E_{D} occurring within a time interval of tint₃₁ (e.g. less than 1 year) from the event E_{A} if the event E_{A} has occurred (A=1), a probability (PP₃₂) of the event E_{D} occurring within a time interval of tint₃₂ (e.g. at least 1 year and less than 2 years) from the event E_{A} if the event E_{A} has occurred (A=1), and probability (PP₃₃) of the event E_{D} occurring within a time interval of tint₃₃ (e.g. at least 2 years) from the event E_{A} if the event E_{A} has occurred (A=1). The node E_{E} shows a probability (PP₄₁), a probability (PP₄₂), and a probability (PP₄₃), in the same manner as the node E_{D}.

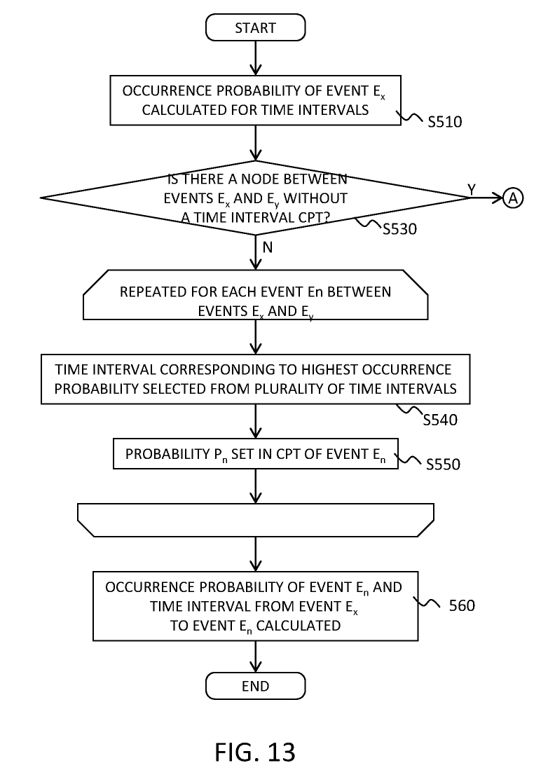

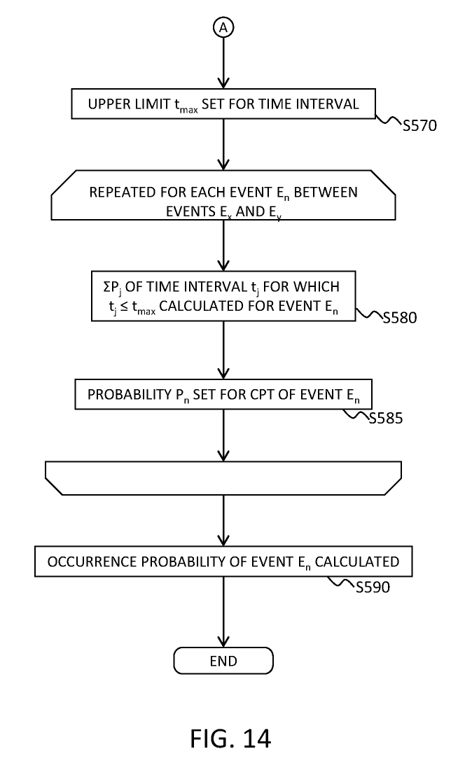

FIG. 13 and FIG. 14 show a detailed exemplary process flow of S500 shown in FIG. 2. In the present embodiment, the information processing apparatus 10 can perform the processing of S500 by performing the processing of S510 to S590. FIG. 13 shows the processing from S510 to S560, and FIG. 14 shows the processing from S570 to S590.

The information processing apparatus 10 can perform the processing from S510 to S590 for a node of a known event, i.e. an event with an occurrence probability of 100%, and/or an event with an occurrence probability greater than or equal to a threshold value, which is referred to as an “occurrence-completed event,” in a BNS instance i.

For example, the information processing apparatus 10 can perform the processing from S510 to 590 on a combination of a node of an occurrence-completed event and a node of another occurrence-completed event that is connected directly thereto or connected thereto via the nodes of one or more unknown events that are not occurrence-completed events, and this combination is sometimes referred to as an “occurrence-completed node combination.” The information processing apparatus 10 can perform the processing from S510 to S590 on each node combination corresponding to events for which at least one node in the occurrence-completed node combination thereof does not include occurrence time information.

The information processing apparatus 10 can perform the processing from S510 to S590 on each BNS instance i of each target i (εI), or can perform the processing from S510 to S590 on only each target i for which a recommendation is to be generated at S700.

First, at S510, the occurrence time estimating section 154 of the event information generating section 150 calculates the occurrence probability of the event Eₓ for each time interval between the node Eₓ and the node E_{y} forming the occurrence-completed node combination. The occurrence time estimating section 154 can calculate the occurrence probability of the event Eₓ for each time interval between the node Eₓ and the node E_{y}, by utilizing a Bayesian Network Probability Propagation software based on the conditional probability table having time intervals generated at S300.

Next, at S530, the occurrence time estimating section 154 judges whether there is a node between the node Eₓ and the node E_{y} that does not have a conditional probability table having time intervals. If it is judged that such a node is present (A in FIG. 13), the occurrence time estimating section 154 proceeds to the process flow described in FIG. 14.

At S530, if it is judged that such a node is not present, the occurrence time estimating section 154 performs the processing from S540 to S550 on the one or more nodes Eₙ between the node Eₓ and the node E_{y}. If there are a plurality of nodes Eₙ, e.g. if there are N nodes and N>1, the processing from S540 to S550 is repeatedly performed for each of the nodes Eₙ (n ε N).

At S540, in the conditional probability table having time intervals, the occurrence time estimating section 154 estimates the time interval during which the occurrence probability is highest, which is the time interval between the event Eₙ corresponding to the node Eₙ and the event Eₙ₋₁ occurring before the event Eₙ (the event Eₓ in a case where N=1), to be the time interval tₙ of the unknown event Eₙ of the target.

For example, if the node E_{A} in FIG. 12 is the node Eₓ, the node E_{D} is the node Eₙ, and the node E_{E} is the node E_{Y}, the occurrence time estimating section 154 estimates a time interval corresponding to the occurrence probability Pₙ that is the highest among the occurrence probabilities PP₃₁ to PP₃₃ within the time interval from Dₜᵢₙₜ₃₁ to Dₜᵢₙₜ₃₃ to be the time interval from the event E_{A} to the event E_{D}.

Next, at S550, the occurrence time estimating section 154 sets the highest occurrence probability Pₙ selected at S540 to be the occurrence probability of the event Eₙ in the conditional probability table without time intervals of the event Eₙ. The occurrence time estimating section 154 performs the processing of S560 after repeating the processing from S540 to S550.

At S560, the occurrence time estimating section 154 calculates the time interval tₙ′ from the event Eₓ to the event Eₙ′0 (n′ ε N) whose occurrence time is being estimated. If N=1, the occurrence time estimating section 154 can set the time interval tₙ of the event Eₙ estimated at S540 as-is to be the time interval tₙ′ from the event Eₓ to the event Eₙ′.

If N>1, the occurrence time estimating section 154 estimates the time interval total Σtₙ of the event Eₙ included from the event Eₓ to the event Eₙ′ to be the time interval from the event Eₓ to the event Eₙ′. The occurrence time estimating section 154 generates the time interval from the event Eₓ to the event Eₙ′ as the unknown event information relating to the event Eₙ′. The occurrence time estimating section 154 can supply the recommend generating section 160 with the generated unknown event information.

FIG. 14 shows an exemplary process flow following A of FIG. 13. First, at S570, the occurrence time estimating section 154 sets an upper limit of the time interval between occurrence-completed events. For example, the occurrence time estimating section 154 sets the upper limit tₘₐₓ of the time interval from the event Eₓ to the event E_{y} to be a predetermined interval. The occurrence time estimating section 154 can receive the upper limit tₘₐₓ of the time interval as input from a user of the information processing apparatus 10.

Next, the occurrence time estimating section 154 performs the processing from S580 to S585 on one or more nodes Eₙ between the node Eₓ and the node E_{y}. If there are a plurality of nodes Eₙ, e.g. if there are N nodes and N>1, the processing from S580 to S585 is repeatedly performed on each node Eₙ (n ε N).

At S580, the occurrence time estimating section 154 calculates the total of the occurrence probability for the time intervals within tₘₐₓ, for the nodes that have a conditional probability table having time intervals corresponding to events from the event Eₓ to the event Eₙ′0 (n′ ε N) whose occurrence time is being estimated.

For example, if the node E_{A} in FIG. 12 is the node Eₓ, the node E_{D} is the node Eₙ′, the node E_{E} is the node E_{Y}, tₘₐₓ is the upper limit of the time interval Dₜᵢₙₜ₃₂, and there is no conditional probability table having time intervals at the node E_{D}, the occurrence time estimating section 154 calculates the total of the occurrence probability in the time interval to be the occurrence probability PP₃₂.

Next, at S585, the occurrence time estimating section 154 sets the total of the occurrence probability calculated at S580 as the occurrence probability of the event Eₙ in a case where the event Eₙ₋₁ has occurred, in the conditional probability table of the node Eₙ. The occurrence time estimating section 154 performs the processing of S590 after the processing of S580 to S585.

At S590, the occurrence time estimating section 154 calculates the occurrence probability of the events corresponding to each node of the BNS instance i, based on the Bayesian network probability propagation. If the occurrence probability of an event is greater than or equal to a predetermined threshold value, e.g. 50%, the occurrence time estimating section 154 can estimate that this event has occurred for the target and generate unknown event information indicating that this event has occurred. The occurrence time estimating section 154 can supply the recommend generating section 160 with the generated unknown event information. The processing from S570 to S590 can be performed by the occurrence estimating section 152 instead of the occurrence time estimating section 154.

In the embodiment explained in relation to FIGS. 13-14, the occurrence probability of each event is determined by the flow of FIG.13 or by the flow of FIG. 14 based on the determination of the step S530. However, the occurrence probability of events can be determined in different manners. For example, the occurrence probability of events can be all determined by the flow of FIG. 13 or the flow of FIG. 14 regardless of the determination of the step S530.

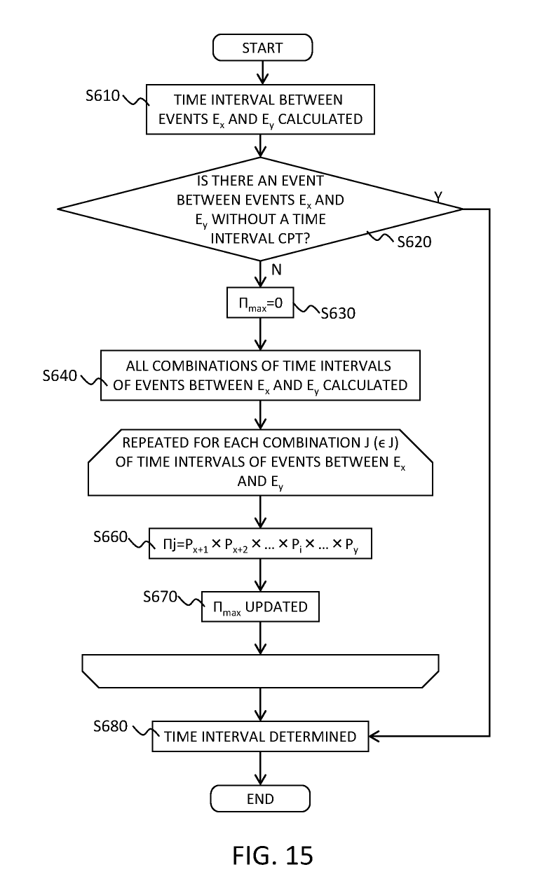

FIG. 15 shows a detailed exemplary process flow of S600 shown in FIG. 2. In the present embodiment, the information processing apparatus 10 can perform the processing of S600 by performing the processing from S610 to S680. The information processing apparatus 10 can perform the processing from S610 to S680 on each node combination in which both nodes correspond to events that include occurrence time information, from among the occurrence-completed node combinations.

First, at S610, the occurrence time estimating section 154 calculates the time interval between the node Eₓ and the node E_{y} forming an occurrence-completed node combination. For example, the occurrence time estimating section 154 identifies the occurrence times of the event Eₓ and the event E_{y} from the known event information of the node Eₓ and the node E_{y}, and calculates the difference between the occurrence times as the time interval between the node Eₓ and the node E_{y}.

At S620, the occurrence time estimating section 154 judges whether there is a node between the node Eₓ and the node E_{y} that does not have a conditional probability table having time intervals. If it is judged that such a node is present, the occurrence time estimating section 154 ends the processing of S600, and if it is judged that no such node is present, the occurrence time estimating section 154 proceeds to the processing of S630.

At S630, the occurrence time estimating section 154 sets the processing variable πₘₐₓ to be 0. Next, at S640, the occurrence time estimating section 154 performs the processing of S660 to S670 on each time interval combination ctⱼ resulting from a node and the node Eₓ and node E_{y}. For example, if the node Eₙ is between the node Eₓ and the node E_{y}, the occurrence time estimating section 154 generates all of the combinations ctⱼ of tₙ+t_{y} for which the sum of the time interval tₙ between the node Eₓ and the node Eₙ and the time interval ty between the node Eₙ and the node E_{y} is equal to the time interval T_{g} between the event Eₓ corresponding to the node Eₓ and the event E_{y} corresponding to the node E_{y} (in other words, every combination where tₙ+t_{y}=T_{g}). The occurrence time estimating section 154 performs the processing from S660 to S670 on each combination ctⱼ included in ct_{J}.

At S660, for the time interval combination ctⱼ, the occurrence time estimating section 154 calculates the occurrence probability product [symbol] ⱼ of each time interval in the probability table having time intervals to be P(tₓ₊₁)×P(tₓ₊₂)× . . . ×P(tₙ)× . . . ×P(t_{y}). Here, P(t) indicates the occurrence probability corresponding to the time interval tin the probability table having time intervals.

For example, a case is imagined in which the node E_{A} in FIG. 12 is the node Eₓ, the node E_{E} is the node E_{y}, the node E_{D} is the node Eₙ, the time interval from the node E_{A} to the node E_{E} is 3 years, and the respective time intervals between Dₜᵢₙₜ₃₁ to Dₜᵢₙₜ₃₃ and Dₜᵢₙₜ₄₁ to Dₜᵢₙₜ₄₃ are “less than 1 year,” “at least 1 year and less than 2 years,” and “2 years or more.” In this case, the occurrence time estimating section 154 can calculate [symbol] ₁=P(Dₜᵢₙₜ₃₁)×P(Dₜᵢₙₜ₄₃) for the first combination ct₁, [symbol] ₂=P(Dₜᵢₙₜ₃₂)×P(Dₜᵢₙₜ₄₂) for the second combination ct₂, and [symbol] ₃=P(Dₜᵢₙₜ₃₃)×P(Dₜᵢₙₜ₄₁) for the third combination ct₃.

Instead of calculating the occurrence probability product [symbol] ⱼ of each time interval in the probability table having time intervals to be P(tₓ₊₁)×P(tₓ₊₂)× . . . ×P(tₙ)× . . . ×P(t_{y}), the occurrence time estimating section 154 can calculate the occurrence probability sum Σⱼ of each time interval in the probability table having time intervals to be P(tₓ₊₁)+P(tₓ₊₂)+ . . . +P(tₙ)+ . . . +P(t_{y}).

Next, at S670, the occurrence time estimating section 154 updates the processing variable [symbol] ₘₐₓ. For example, if the most recently calculated [symbol] ⱼ is greater than [symbol] ₘₐₓ, the occurrence time estimating section 154 performs an update making the most recently calculated [symbol] ⱼ the new [symbol] ₘₐₓ.

Next, at S680, the occurrence time estimating section 154 determines the occurrence time of the event corresponding to the node between the node Eₓ and the node E_{y}, based on the processing variable [symbol] ₘₐₓ. For example, the occurrence time estimating section 154 determines the occurrence time of the event corresponding to the node between the node Eₓ and the node E_{y} to be the combination of time intervals included in the combination ctⱼ resulting in the processing variable [symbol] ₘₐₓ at the time when the repetition of the processing from S660 to S670 is finished.

For example, if [symbol] ₂ exemplified in S660 becomes [symbol] ₘₐₓ, the occurrence time estimating section 154 determines the time interval between the event E_{A} and the event E_{D} to be Dₜᵢₙₜ₃₂ and determines the time interval between the event E_{D} and the event E_{E} to be Dₜᵢₙₜ₄₂. The occurrence time estimating section 154 can generate the unknown event information relating to the node E_{y} and a node between the node Eₓ and the node E_{y} to each be the time interval of the node between the node Eₓ and the node E_{y}. The occurrence time estimating section 154 can supply the recommend generating section 160 with the generated unknown event information.

As a result of the processing from S610 to S680, the occurrence time estimating section 154 determines the time interval of three or more events to be two or more time intervals during which the sum or product of the occurrence probability of two or more time intervals included between three or more events in a conditional probability table having time intervals, where the sum of these two or more time intervals does not exceed the time intervals of the first event and the last event among the three or more events. Furthermore, the occurrence time estimating section 154 estimates the time at which an unknown event of a target occurs, according to the identified time interval.

In this way, by performing the processing from S100 to S700, the information processing apparatus 10 can estimate whether an unknown event has occurred for a target and estimate the occurrence time of the unknown event, based on the public first-order statistical information and the known event information of the target. Therefore, even when a salesperson cannot obtain information relating to sensitive events from a target, the information processing apparatus 10 can provide suitable recommendations to the target.

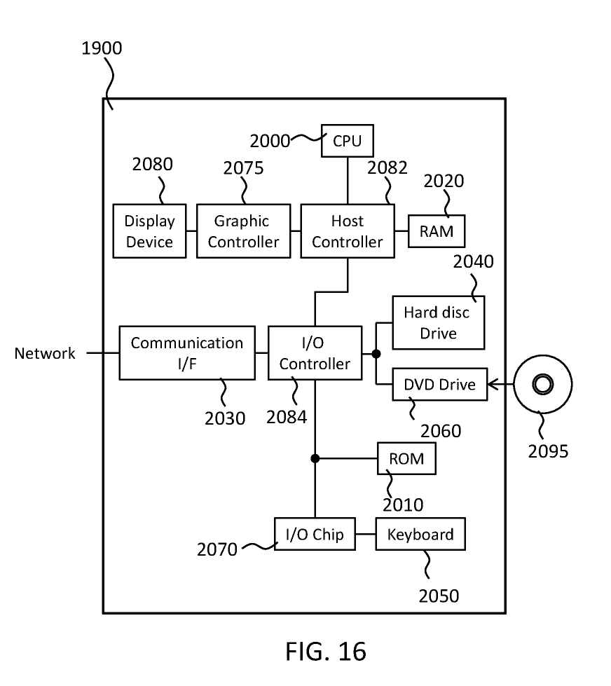

FIG. 16 shows an exemplary configuration of a computer 1900 according to an embodiment of the invention. The computer 1900 according to the present embodiment includes a CPU 2000, a RAM 2020, a graphic controller 2075, and a display apparatus 2080, which are mutually connected by a host controller 2082. The computer 1900 also includes input/output units such as a communication interface 2030, a hard disk drive 2040, and a DVD-ROM drive 2060, which are connected to the host controller 2082 via an input/output controller 2084. The computer also includes legacy input/output units such as a ROM 2010 and a keyboard 2050, which are connected to the input/output controller 2084 through an input/output chip 2070. The host controller 2082 connects the RAM 2020 with the CPU 2000 and the graphic controller 2075, which access the RAM 2020 at a high transfer rate. The CPU 2000 operates according to programs stored in the ROM 2010 and the RAM 2020, thereby controlling each unit. The graphic controller 2075 obtains image data generated by the CPU 2000 on a frame buffer or the like provided in the RAM 2020, and causes the image data to be displayed on the display apparatus 2080. Alternatively, the graphic controller 2075 can contain therein a frame buffer or the like for storing image data generated by the CPU 2000.

The input/output controller 2084 connects the host controller 2082 with the communication interface 2030, the hard disk drive 2040, and the DVD-ROM drive 2060, which are relatively high-speed input/output units. The communication interface 2030 communicates with other electronic devices via a network. The hard disk drive 2040 stores programs and data used by the CPU 2000 within the computer 1900. The DVD-ROM drive 2060 reads the programs or the data from the DVD-ROM 2095, and provides the hard disk drive 2040 with the programs or the data via the RAM 2020.

The ROM 2010 and the keyboard 2050 and the input/output chip 2070, which are relatively low-speed input/output units, are connected to the input/output controller 2084. The ROM 2010 stores therein a boot program or the like executed by the computer 1900 at the time of activation, a program depending on the hardware of the computer 1900. The keyboard 2050 inputs text data or commands from a user, and can provide the hard disk drive 2040 with the text data or the commands via the RAM 2020. The input/output chip 2070 connects a keyboard 2050 to an input/output controller 2084, and can connect various input/output units via a parallel port, a serial port, a keyboard port, a mouse port, and the like to the input/output controller 2084.

A program to be stored on the hard disk drive 2040 via the RAM 2020 is provided by a recording medium as the DVD-ROM 2095, and an IC card. The program is read from the recording medium, installed into the hard disk drive 2040 within the computer 1900 via the RAM 2020, and executed in the CPU 2000.

A program that is installed in the computer 1900 can cause the computer 1900 to function as an apparatus, such as the information processing apparatus 10 of FIG. 1. The program can include the statistics obtaining module, the probability calculating module, the target information obtaining module, the BN generating module, the event information generating module, the occurrence estimating module, the occurrence time estimating module, and the recommend generating module. The program or module acts on the CPU 2000, to cause the computer 1900 to function as a section, component, element of the apparatus 100, such as the statistics obtaining section 110, the probability calculating section 120, the target information obtaining section 130, the BN generating section 140, the event information generating section 150, the occurrence estimating section 152, the occurrence time estimating section 154, and the recommend generating section 160.

The information processing described in these programs is read into the computer 1900 such as the information processing apparatus 10 of FIG.1, to function as the statistics obtaining section 110, the probability calculating section 120, the target information obtaining section 130, the BN generating section 140, the event information generating section 150, the occurrence estimating section 152, the occurrence time estimating section 154, and the recommend generating section 160, which is the result of cooperation between the program or module and the above-mentioned various types of hardware resources. Moreover, the information processing apparatus 10 is constituted by realizing the operation or processing of information in accordance with the usage of the computer 1900.

For example, in response to communication between the computer 1900 and an external device, the CPU 2000 can execute a communication program loaded onto the RAM 2020, to instruct communication processing to a communication interface 2030, based on the processing described in the communication program. The communication interface 2030, under control of the CPU 2000, reads the transmission data stored on the transmission buffering region provided in the recording medium, such as a RAM 2020, a hard disk drive 2040, or a DVD-ROM 2095, and transmits the read transmission data to a network, or writes reception data received from a network to a reception buffering region or the like provided on the recording medium. In this way, the communication interface 2030 can exchange transmission/reception data with the recording medium by a DMA (direct memory access) method, or by a configuration that the CPU 2000 reads the data from the recording medium or the communication interface 2030 of a transfer destination, to write the data into the communication interface 2030 or the recording medium of the transfer destination, so as to transfer the transmission/reception data.

In addition, the CPU 2000 can cause all or a necessary portion of the file of the database to be read into the RAM 2020 such as by DMA transfer, the file or the database having been stored in an external recording medium such as the hard disk drive 2040, the DVD-ROM drive 2060(DVD-ROM 2095) to perform various types of processing onto the data on the RAM 2020. The CPU 2000 can then write back the processed data to the external recording medium by means of a DMA transfer method or the like. In such processing, the RAM 2020 can be considered to temporarily store the contents of the external recording medium, and so the RAM 2020, the external recording apparatus, and the like are collectively referred to as a memory, a storage section, a recording medium, a computer readable medium, etc.

For example, the storage section of the information processing apparatus 10 can store data that is received from and/or provided to the statistics obtaining section 110, the probability calculating section 120, the target information obtaining section 130, the BN generating section 140, the event information generating section 150, the occurrence estimating section 152, the occurrence time estimating section 154, and the recommend generating section 160. As an example, the storage section can receive and store statistical data relating to events obtained by the statistics obtaining section 110, BNS instances supplied to the event information generating section 150 by the BN generating section 140, and the like.

According to a first aspect of the present invention, provided is an information processing apparatus including a target information obtaining section that obtains known event information relating to at least one known event that has occurred for a target; an information processing apparatus that obtains statistical data relating to events; and an event information generating section that generates unknown event information relating to an unknown event of the target, based on the statistical data and the known event information. Also provided is an information processing method using the information processing apparatus and a program used by the information processing apparatus. According to a second aspect of the present invention, provided is the information processing apparatus according to the first aspect including a probability calculating section that calculates an event occurrence probability based on the statistical data. According to a third aspect of the present invention, provided is the information processing apparatus according to the second aspect, wherein the probability calculating section calculates an occurrence probability of a second event occurring if a first event occurs. According to a fourth aspect of the present invention, provided is the information processing apparatus according to the second aspect, wherein the probability calculating section calculates an occurrence probability of a second event occurring if a first event occurs, for each time interval of the first event and the second event. According to a fifth aspect of the present invention, provided is the information processing apparatus according to any one of the first-fourth aspects, further including: a BN generating section that generates a Bayesian network (BN) including a plurality of events as nodes, based on the event occurrence probability, wherein the event information generating section generates the unknown event information based on the Bayesian network. According to a sixth aspect of the present invention, provided is the information processing apparatus according to the fifth aspect, wherein the BN generating section generates a conditional probability table having time intervals, for each node in the Bayesian network. According to a seventh aspect of the present invention, provided is the information processing apparatus according to the sixth aspect, wherein the event information generating section estimates a time at which the unknown event of the target occurred, based on the conditional probability table having time intervals. According to an eighth aspect of the present invention, provided is the information processing apparatus according to the seventh aspect, wherein the occurrence time estimating section estimates the time interval of the unknown event of the target to be a time interval during which the occurrence probability is highest in the conditional probability table having time intervals.

According to a ninth aspect of the present invention, provided is the information processing apparatus according to the seventh aspect, wherein the occurrence time estimating section identifies a time interval of three or more events, based on a sum or product of the occurrence probabilities of two or more time intervals included between the three or more events in the conditional probability table having time intervals, and the information processing apparatus estimates the time at which the unknown event of the target occurred based on the identified time interval. According to a tenth aspect of the present invention, provided is the information processing apparatus according to the ninth aspect, wherein the occurrence time estimating section identifies the time interval of the three or more events to be a time interval in which the sum or product of the occurrence probabilities of the two or more time intervals included between the three or more events in the conditional probability table having time intervals is highest, where the sum of the two or more time intervals does not exceed a time interval of a first event and a time interval of a last event among the three or more events, and the information processing apparatus estimates the time at which the unknown event of the target occurred based on the identified time interval. According to an eleventh aspect of the present invention, provided is the information processing apparatus according to any one of the fifth-tenth aspects, wherein the event information generating section includes an occurrence estimating section that estimates whether the unknown event of the target has occurred for the target from the known event information, based on the Bayesian network. According to a twelfth aspect of the present invention, provided is the information processing apparatus according to the eleventh aspect, further including: a recommend generating section that generates information to be recommended to the target in relation to the unknown event, based on the unknown event information. According to a thirteenth aspect of the present invention, provided is the information processing apparatus according to the twelfth aspect, wherein the event information generating section generates unknown event information indicating that an unknown event whose occurrence probability of having occurred for the target is greater than or equal to a threshold value has occurred for the target, and the recommend generating section generates the information to be recommended for the unknown event whose unknown event information indicates that the unknown event has occurred for the target. According to a fourteenth aspect of the present invention, provided is the information processing apparatus according to any one of the first-thirteenth aspects, wherein the information processing apparatus: obtains first-order statistical information from an external server, generates statistical data by gathering the first-order statistical information, obtains synonym data including a plurality of expressions relating to events, and obtains statistical data relating to two events, by matching an expression of the statistical data that matches expressions relating to the two events, based on the synonym data. According to a fifteenth aspect of the present invention, provided is the information processing apparatus according to any one of the fifth-thirteenth aspects, wherein the information processing apparatus obtains the statistical data for each category of the events, the BN generating section identifies a category with which the target is associated, based on an association of the target, and the event information generating section generates the unknown event information based on the statistical data of the category with which the target is associated. According to a sixteenth aspect of the present invention, provided is the information processing apparatus according to any one of the first-fifteenth aspects, wherein the event is a life event relating to the target.

Various types of information, such as various types of programs, data, tables, and databases, can be stored in the recording apparatus, to undergo information processing. Note that the CPU 2000 can also use a part of the RAM 2020 to perform reading/writing thereto on the cache memory. In such an embodiment, the cache is considered to be contained in the RAM 2020, the memory, and/or the recording medium unless noted otherwise, since the cache memory performs part of the function of the RAM 2020.

The CPU 2000 can perform various types of processing, onto the data read from a memory such as the RAM 2020, which includes various types of operations, processing of information, condition judging, search/replace of information, etc., as described in the present embodiment and designated by an instruction sequence of programs, and writes the result back to the memory such as the RAM 2020. For example, if performing condition judging, then the CPU 2000 can judge whether each type of variable shown in the present embodiment is larger, smaller, no smaller than, no greater than, or equal to the other variable or constant, and if the condition judging results in the affirmative (or in the negative), then the process branches to a different instruction sequence, or calls a sub routine.

In addition, the CPU 2000 can search for information in a file, a database, etc., in the recording medium. For example, if a plurality of entries, each having an attribute value of a first attribute is associated with an attribute value of a second attribute, are stored in a recording apparatus, then the CPU 2000 can search for an entry matching the condition whose attribute value of the first attribute is designated, from among the plurality of entries stored in the recording medium, and reads the attribute value of the second attribute stored in the entry, thereby obtaining the attribute value of the second attribute associated with the first attribute satisfying the predetermined condition.

The above-explained program or module can be stored in an external recording medium. Exemplary recording mediums include a DVD-ROM 2095, as well as an optical recording medium such as a Blu-ray Disk or a CD, a magneto-optic recording medium such as a MO, a tape medium, and a semiconductor memory such as an IC card. In addition, a recording medium such as a hard disk or a RAM provided in a server system connected to a dedicated communication network or the Internet can be used as a recording medium, thereby providing the program to the computer 1900 via the network.

The present invention can be a system, a method, and/or a computer program product. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium, which can implement the storage section, can be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server.

In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions can also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which includes one or more executable instructions for implementing the specified logical function(s).

In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In cases where a plurality of elements are provided as example in the description of the present embodiment, elements other than the elements provided as examples can be used. For example, if the description includes a phrase such as “X performs Y using A, B, and C,” then X can perform Y using D in addition to A, B, and C.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. An information processing apparatus comprising:
a target information obtaining section that obtains known event information relating to at least one known event that has occurred for a target;
an information processing apparatus that obtains statistical data relating to events; and
an event information generating section that generates unknown event information relating to an unknown event of the target, based on the statistical data and the known event information.

2. The information processing apparatus according to claim 1, comprising:
a probability calculating section that calculates an event occurrence probability based on the statistical data.

3. The information processing apparatus according to claim 2, wherein
the probability calculating section calculates an occurrence probability of a second event occurring if a first event occurs.

4. The information processing apparatus according to claim 2, wherein
the probability calculating section calculates an occurrence probability of a second event occurring if a first event occurs, for each time interval of the first event and the second event.

5. The information processing apparatus according to claim 1, further comprising:
a BN generating section that generates a Bayesian network (BN) including a plurality of events as nodes, based on the event occurrence probability, wherein the event information generating section generates the unknown event information based on the Bayesian network.

6. The information processing apparatus according to claim 5, wherein
the BN generating section generates a conditional probability table having time intervals, for each node in the Bayesian network.

7. The information processing apparatus according to claim 6, wherein
the event information generating section estimates a time at which the unknown event of the target occurred, based on the conditional probability table having time intervals.

8. The information processing apparatus according to claim 7, wherein
the occurrence time estimating section estimates the time interval of the unknown event of the target to be a time interval during which the occurrence probability is highest in the conditional probability table having time intervals.

9. The information processing apparatus according to claim 7, wherein
the occurrence time estimating section identifies a time interval of three or more events, based on a sum or product of the occurrence probabilities of two or more time intervals included between the three or more events in the conditional probability table having time intervals, and the information processing apparatus estimates the time at which the unknown event of the target occurred based on the identified time interval.

10. The information processing apparatus according to claim 9, wherein
the occurrence time estimating section identifies the time interval of the three or more events to be a time interval in which the sum or product of the occurrence probabilities of the two or more time intervals included between the three or more events in the conditional probability table having time intervals is highest, where the sum of the two or more time intervals does not exceed a time interval of a first event and a time interval of a last event among the three or more events, and the information processing apparatus estimates the time at which the unknown event of the target occurred based on the identified time interval.

11. The information processing apparatus according to claim 5, wherein
the event information generating section includes an occurrence estimating section that estimates whether the unknown event of the target has occurred for the target from the known event information, based on the Bayesian network.

12. The information processing apparatus according to claim 11, further comprising:
a recommend generating section that generates information to be recommended to the target in relation to the unknown event, based on the unknown event information.

13. The information processing apparatus according to claim 12, wherein
the event information generating section generates unknown event information indicating that an unknown event whose occurrence probability of having occurred for the target is greater than or equal to a threshold value has occurred for the target, and the recommend generating section generates the information to be recommended for the unknown event whose unknown event information indicates that the unknown event has occurred for the target.

14. The information processing apparatus according to claim 1, wherein the information processing apparatus:
obtains first-order statistical information from an external server;
generates statistical data by gathering the first-order statistical information;
obtains synonym data including a plurality of expressions relating to events; and
obtains statistical data relating to two events, by matching an expression of the statistical data that matches expressions relating to the two events, based on the synonym data.

15. The information processing apparatus according to claim 5, wherein
the information processing apparatus obtains the statistical data for each category of the events;
the BN generating section identifies a category with which the target is associated, based on an association of the target; and
the event information generating section generates the unknown event information based on the statistical data of the category with which the target is associated.

16. The information processing apparatus according to claim 1, wherein
the event is a life event relating to the target.

17. An information processing method performed by a computer, comprising:
obtaining known event information relating to at least one known event that has occurred for a target;
obtaining statistical data relating to events; and
generating unknown event information relating to an unknown event of the target, based on the statistical data and the known event information.

18. The information processing method according to claim 17, comprising:
calculating an event occurrence probability based on the statistical data.

19. The information processing method according to claim 18, wherein
the calculating includes calculating an occurrence probability of a second event occurring if a first event occurs.

20. The information processing method according to claim 18, wherein
the calculating includes calculating an occurrence probability of a second event occurring if a first event occurs, for each time interval of the first event and the second event.

21. A program that, when executed by a computer, causes the computer to function as:
a target information obtaining section that obtains known event information relating to at least one known event that has occurred for a target;
an information processing apparatus that obtains statistical data relating to events; and
an event information generating section that generates unknown event information relating to an unknown event of the target, based on the statistical data and the known event information.

22. The program according to claim 21, further causing the computer to function as:
a probability calculating section that calculates an event occurrence probability based on the statistical data.

23. The program according to claim 22, wherein
the probability calculating section calculates an occurrence probability of a second event occurring if a first event occurs.

24. The program according to claim 22, wherein
the probability calculating section calculates an occurrence probability of a second event occurring if a first event occurs, for each time interval of the first event and the second event.

25. A storage medium storing thereon the program according to claim 21.
